(19) United States
(12) Patent Application Publication
(10) Pub. No.: US 2003/0009408 A1
(43) Pub. Date: Jan. 9, 2003

(54) Providing financial portfolio risk measurement and analysis to remote client services via a network-based application programming interface

(76) Inventor: Ittai Korin, New York, NY (US)

Correspondence Address: Paul D. Greeley, Esq., Ohlandt, Greeley, Ruggiero & Perle, L.L.P., 10th Floor, One Landmark Square, Stamford, CT, 06901-2682, US

(21) Appl. No.: 10/132,867

(22) Filed: Apr. 25, 2002

Related U.S. Application Data
(60) Provisional application No. 60/286,791, filed on Apr. 26, 2001.

(51) Int. Cl. G06F 17/60

(52) U.S. Cl. 705/36

(57) ABSTRACT

There is provided a computer system having a module for controlling a processor to receive a request via a network for a risk analysis of an investment, pass the request to a risk analysis engine, receive a result of the risk analysis from the risk analysis engine, and send the result to a client device via the network.

### CROSS REFERENCE TO RELATED APPLICATIONS

The present application is claiming priority of U.S. Provisional Patent Application Serial No. 60/286,791, which was filed on Apr. 26, 2001.

### BACKGROUND OF THE INVENTION

1. Field of the Invention

The present invention relates to a computer module risk analysis of an investment, and more particularly, to application program interface (API) that provides an interface for a risk analysis engine.

2. Description of the Prior Art

A financial service entity, such as a securities brokerage, investment advisor, or bank, can provide a variety of investment services to a customer who maintains an investment portfolio within an electronic data processing system. Such investment services include, for example, online trading, reporting current value of a portfolio, and reporting historical performance.

In the interest of offering timely service, as well as to avoid the complexity of development, hardware, software, and data management, the financial service entity may wish to dynamically access and embed a set of risk analysis functions provided by a third party Application Service Provider (ASP). This embedding would result in the addition and close integration of these third party functions within the financial service entity's application. As such, the risk management functions would reside on a server processor affiliated with the ASP.

Existing risk management systems have been created to reside on the same processors and servers used by the financial service entity. This means that the financial service entity must undergo the time and labor expense of locally installing risk management software as well as supplying additional hardware for it to run on. Additional hardware is often necessary due to processor-intensive calculations, which may not execute in a timely or feasible manner on machines currently used by the financial service entity. In addition to hardware and software, risk management applications require market data inputs, i.e., current and historical security prices. This means that in addition to more software and computers, existing risk management systems require a financial service entity to incur the cost and labor of maintaining and updating a market database.

There is a need for an improved method for financial portfolio risk measurement and analysis that accesses portfolio risk analysis features, at runtime, in a networked and distributed manner.

### SUMMARY OF THE INVENTION

The present invention enables a financial service entity to provide portfolio risk analysis functions to a customer. The customer, as a result, would then be able to access a range of risk measurement functions, and apply the functions to his or her own electronically stored investment portfolio.

The primary components of a system in accordance with the present invention include a customer workstation, a financial service processor and a server processor. The server processor includes an analytical engine for performing a risk analysis, and an application program interface (API) that allows a device external to the server processor to access the analytical engine.

In one embodiment of the present invention, the customer uses the customer workstation to access the financial service processor, which in turn sends a request to the server processor for a risk analysis. The server processor performs the risk analysis and returns a result to the financial processor, and the financial processor sends the result to the customer workstation. In an alternative embodiment of the invention, the customer workstation sends a request to the server processor for a risk analysis, and the server processor returns the result tot the customer workstation. Regardless of whether the request is sent by the financial service processor or the customer workstation, the request is embedded in an application program interface (API) call to the API on the server processor.

An embodiment of the present invention is a computer system having a module for controlling a processor to receive a request via a network for a risk analysis of an investment, pass the request to a risk analysis engine, receive a result of the risk analysis from the risk analysis engine, and send the result to a client device via the network.

Another embodiment of the invention is a computer system having (i) a processor, (ii) a risk analysis engine for controlling the processor to perform a risk analysis of an investment; and (iii) an application program interface (API) for controlling the processor to:

(a) receive an API call via a network, where the API call includes a request for the risk analysis;

(b) pass the request to the risk analysis engine;

(c) receive a result of the risk analysis from the risk analysis engine; and

(d) send the result to a client device via the network.

The request includes data describing the investment. The risk analysis engine includes a plurality of risk analysis functions, and the request includes data that selects a member of the plurality of risk analysis functions.

The present invention also includes an embodiment in a storage media containing instructions for controlling a processor. The storage media includes instructions for controlling the processor to receive a request for a risk analysis of an investment, pass the request to a risk analysis engine, receive a result of the risk analysis from the risk analysis engine, and send the result to a client device via the network.

Another embodiment of the invention is an application program interface (API) for controlling a processor to (a) receive a an API call via a network, where the API call includes a request for a risk analysis of an investment, (b) pass the request to a risk analysis engine, (c) receive a result of the risk analysis from the risk analysis engine, and (d) send the result to a client device via the network. The request includes data describing the investment, the risk analysis engine includes a plurality of risk analysis functions, and the request includes data that selects a member of the plurality of risk analysis functions.

### BRIEF DESCRIPTION OF THE DRAWINGS

FIG. 1 is a block diagram of a networked computer system configured for employment of the present invention.

FIG. 2 is a flowchart of a method for setting up a request for a risk analysis, using an API call.

FIG. 3 is a flowchart of a method for processing a request for a risk analysis via an API.

### DESCRIPTION OF THE INVENTION

Before proceeding with a description of the present invention, it is well to define several terms as used herein.

A “financial service entity” is an entity, typically a corporation or company, that provides investment, money management, brokerage, or advice/planning for another entity, typically an individual or a corporate entity.

An “application service provider (ASP)” is an entity, that provides a functionality of a software application via a remote interface or delivery method.

An “asset” is anything considered as having a positive monetary value. Assets include holdings of obvious market value (cash, real estate, securities), harder-to-measure value (inventory, aging equipment), and other quantities (pre-paid expenses, goodwill) considered assets by accounting conventions but possibly having no market value at all.

A “financial instrument” is: (a) a debt security; (b) an equity security; (c) an insurance policy; (d) an interest in a partnership, a trust or the estate of a deceased individual, or any right in respect of such an interest; (e) a precious metal; (f) an option or a contract for the future supply of a commodity, where the option or contract is traded on a recognized commodity exchange; (g) a prescribed instrument; (h) a guarantee, an acceptance or an indemnity in respect of anything described in paragraphs (a), (b), (d), (e) or (g); or (i) an option or a contract for the future supply of money or anything described in any of paragraphs (a) to (h).

A “portfolio” is a plurality of financial instruments.

An “asset class” is a logical grouping of assets into a category whose members share common traits. For example, all stock investments are grouped into an asset class know as equities, since they all commonly represent equity positions in various companies. All currency positions in a portfolio are grouped into an asset class labeled foreign exchange.

A “market sector” is a logical grouping of assets into companies that belong to the same class of business. For example, all stocks of technology related companies are labeled technology sector stocks.

“Risk” is a calculated currency amount representing a potential gain or loss that a series of investments or investment portfolios could realize over a specified period of time.

“Dollar risk” is a calculated dollar amount that can be gained or lost in an investment.

“Volatility” is a mathematical representation of a size of an expected fluctuation in a price of an asset. More technically, it is a standard deviation, which is an average size of a square of a deviation, of a price from its mean.

“Historical volatility” is a measurement of price volatility taken over a set of prices occurring over a historical time period such as a week, a month, a year, or several years.

“Value at risk” is a measurement used to estimate a potential loss or gain in a given investment or set of investments. Historical value at risk (VAR) uses historical price volatility and a statistical distribution to approximate behavior of an asset's, or group of assets', future price behavior. The approximation is calculated within a given range of confidence. The result is an estimation of potential loss or gain with a 95% degree of confidence and a 5% degree of error. This 95% degree of confidence is a commonly accepted industry standard when referring to Value at Risk. Of the methods used to calculate VaR, almost all existing industry standard manifestations commonly aim to provide a result with this 95% standard.

“Return” is an absolute or percentage amount gained or lost in an investment over a given time period.

“Distributed” is a description of a software system architecture that locates components of a software application on separate, but networked computers. This is in contrast to having all the components of a software application residing on the same computer. A distributed software application is spread over several computers that are connected via a network.

“Runtime” refers to a condition and state that exists when a program is being executed. When something is accessed at runtime it is accessed dynamically, as opposed to being accessed off-line or before a program is executed.

“Thread” is a single sequential flow of control within a program. A single thread also has a beginning, a sequence, and an end and at any given time during the runtime of the thread, there is a single point of execution. However, a thread itself is not a program; it cannot run on its own. Rather, it runs within a program.

The present invention includes a system through which a client device can make a dynamic request for a risk analysis, via a network, to a server device, which then returns a result of the risk analysis to the client device. Risk analysis typically includes a risk calculation. The request contains composition details of a financial portfolio, such as an asset symbol, a quantity, and/or a purchase date. The result may contain a single or multiple set of calculation results, including graphical representations.

The requests are made through a structured format, commonly referred to as an Application Programming Interface (API). An API is a method prescribed by a computer operating system or a first application program through which a programmer writing a second application program can make a request of the operating system or the first application program. This means that from within a given program, it is possible to make functional requests from another program that is currently running on a processor. For example, a certain computer may contain a first program that calculates the average of a series of numbers. If this first program has an API that exposes this capability, it would then be possible to create a second program that uses the API to also calculate the average of a series of numbers. The API of the first program allowed the creator of the second program to avoid having to generate this feature from scratch.

The API of the present invention allows the client to generate the request in an API call and display the result in a chosen format in order to maintain interface consistency. Interface consistency is the presentation of results and information in a consistent look and feel. This means that even though new features are added to a financial service entity's application, since the API allows full programmatic control, the results can be displayed in a manner familiar to the other features which may be currently supplied by the financial service entity.

In addition, the request may be mixed and matched to create new and unique functionality combinations as desired by the client. An example of such a mix is one where a financial service entity uses an existing feature on its system to sort equity positions in a customer's portfolio by geographic region. Each of these geographic groups of stocks are then risk analyzed, using an API call. The result is a portfolio risk analysis based on geographic risk. In this example, two disparate features are combined to create a useful result.

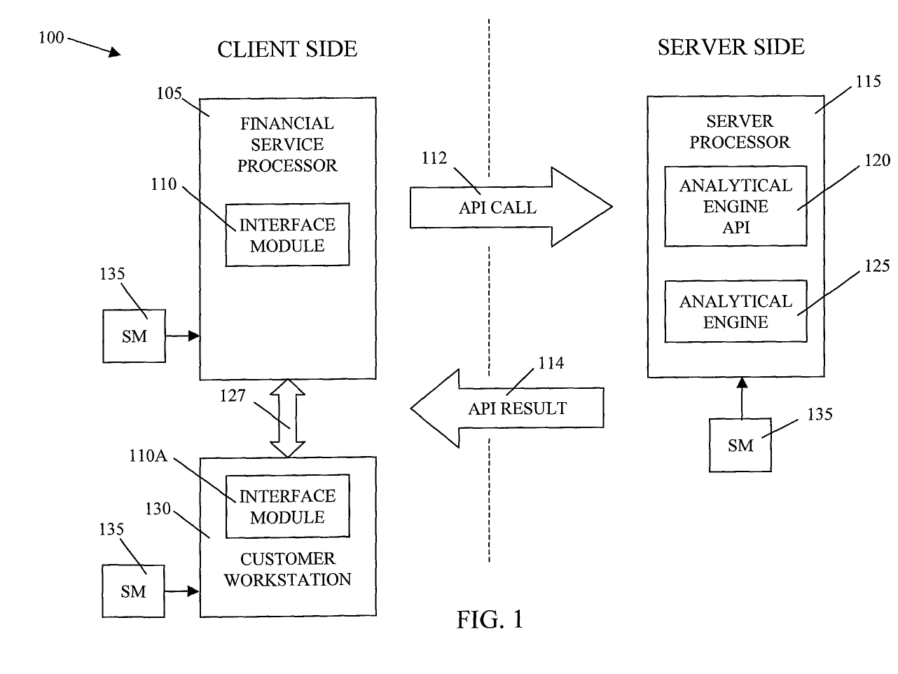

FIG. 1 is a block diagram of a networked computer system 100 configured for employment of the present invention. The principal components of system 100 are a financial service processor 105, a server processor 115 and a customer workstation 130. Processors 105 and 115, and customer workstation 130 are each coupled to a network (not shown), such as the Internet, through which they can communicate with one another. Conceptually, processor 105 and customer workstation 130 are located on a client side of the network, and processor 155 is on a server side of the network.

In FIG. 1, communications between the principal components of system 100 are represented by block arrows. For example, there is bidirectional communication 127 between workstation 130 and processor 105. Also, an API call 112 is sent from the client side of system 100 to processor 115, and processor 115 returns an API result 114 to the client side.

In one embodiment of system 100, processor 105 sends API call 112 and receives API result 114. In an alternative embodiment, workstation 130 sends API call 112 and receives API result 114. In other words, the present invention contemplates communication between either of processor 105 or workstation 130, and processor 115.

Server processor 115 is a conventional network server device that has an associated memory (not shown) that includes data and instructions for controlling processor 115, and in particular an analytical engine 125 and an analytical engine API 120. Analytical engine 125 and API 120 are software modules.

Analytical engine 125 performs a risk analysis. The analytical engine is part of a collection of server-side software, hardware and stored data that make up the risk management application. The risk analysis can encompass any conventional risk analysis function. Preferably, a user of the present invention is permitted to select from variety of such functions. By way of example, and not limitation, analysis engine 125 provides risk analysis functions such as:

1. Financial Instrument Risk Calculation—Computes a value at risk of a financial instrument.

2. Financial Instrument Historical Risk Calculation—Computes a historical value at risk of a financial instrument.

3. Financial Instrument Stress Test Risk Calculation—Computes a possible value fluctuation of a financial instrument, given a user-defined simulated market event.

4. Financial Instrument Index Comparison Risk Calculation—Computes a comparison of risk of a financial instrument versus risk of an equivalent market value invested in a market index.

5. Financial Instrument Volatility Calculation—Computes an historical volatility of a financial instrument.

6. Financial Instrument Value Calculation—Computes a current market value of a financial instrument.

7. Financial Instrument Profit Calculation—Computes a profit over a given period of time of a financial instrument.

8. Financial Instrument Sector Sort Calculation—Sorts a financial instrument into a market sector/industry grouping, e.g., a market sector/industry grouping found in an equity and corporate bond market.

9. Financial Instrument Asset Sort Calculation—Sorts a financial instrument into an associated asset grouping, e.g., equities, bonds, commodities, currencies.

If desired, each of the aforementioned risk analysis functions can operate on a plurality of financial instruments, rather than merely a single financial instrument. Also, these functions can be employed for either of an individual risk analysis or an aggregate risk analysis.

Individual risk analysis is an analysis of a risk of an individual position, such as 100 shares of XYZ, Inc. It also encompasses determining an individual risk for each of a plurality of companies, e.g., risk of XYZ, Inc., and separately, risk of PQR, Inc.

Aggregate risk analysis is an analysis of a collective risk of a plurality of positions. For example, collective risk of owning 100 shares of XYZ, Inc. and 100 shares of PQR, Inc. XYZ, Inc. and PQR, Inc could both be risky when each is considered as an individual, yet their collective risk might not be high. For example, under a particular market condition, XYZ, Inc. stock could have a tendency to rise and PQR, Inc. stock could have a tendency to fall, but their collective risk is relatively low as their opposite tendencies cancel one another.

API call 112 includes data relating to an investment, and serves as a request for analytical engine 125 to perform a risk analysis of the investment. API result 114 includes a result of the risk analysis.

API 120 exposes the functionality of analytical engine 125 to components outside of processor 115. That is, API 120 provides an interface between the outside components and analytical engine 125. API 120 receives API call 112 from the client side of system 100, extracts data therefrom, and passes the data to analytical engine 125. API 120 receives a risk analysis result from analytical engine 125, and returns the result to the client side of system 100 via API result 114.

Financial service processor 105 includes an associated memory (not shown) that includes data and instructions for controlling processor 105, and in particular an interface module 110. Interface module 110 is a software module for issuing API call 112 and receiving API result 114.

Workstation 130 is a conventional computer. As such, it may be implemented as a general purpose microcomputer, such as one of the members of the Sun™ Microsystems family of computer systems, one of the members of the IBM™ Personal Computer family, or any conventional portable or wireless computer device. Workstation 130 includes a memory (not shown) that includes data and instructions for controlling workstation 130, and in particular it may have installed therein an interface module 110A. Interface module 110A is a software module that has a functionality similar to that of interface module 110. That is, interface module 110A is for issuing API call 112 and receiving API result 114.

Interface module 110 and interface module 110A are preferably structured as APIs, and each mirrors the functionality of API 120. This means that interface modules 110 and 110A can contain a series of feature methods that are exposed and made available programmatically. The relationship between interface methods 110 and 110A and the functions of analytical engine 125 that reside and execute on the server side can be a one-to-one relationship. Interface modules 110 and 110A may contain a method that generates a portfolio VaR calculation. However, this interface method does not actually calculate the VaR. Rather, this method only passes along the request to an associated server-side VaR method that then actually executes the calculation. This functional relationship between the interface method and the server-side method is an example of mirroring.

In one embodiment of system 100, workstation 130 communicates with processor 105. Workstation 130 runs an application, such as a web browser, that uses the Internet or some network to access features provided by processor 105. Processor 105, in turn, employs interface module 110 to send a risk analysis request, via API 120, to analytical engine 125. Thereafter, interface module 110 receives API result 114. Processor 105 then presents the API result in a chosen format and uses the Internet or some network to send the result back to the application running on the workstation 130.

In an alternative embodiment of system 100, workstation 130 employs interface module 110A to send a risk analysis request, via API 120, to analytical engine 125. Thereafter, interface module 110A receives API result 114. Note that this alternative embodiment does not involve processor 105.

In another alternative embodiment, processor 105 can be an originator of a request for a risk analysis, where the result is sent from processor 115 to workstation 130. Such an arrangement would be appropriate for example, where the customer wishes to periodically receive a risk report, automatically. As such, processor 105 runs a program (not shown) that periodically sends API call 112 to processor 115, and processor 115 send the result to workstation 130 via email.

Although system 100 is described herein as having the instructions for the method of the present invention installed into memories of processor 105, processor 115 and workstation 130, the instructions can reside on an external storage media 135 for subsequent loading into the memories of processor 105, processor 115 and workstation 130. Storage media 135 can be any conventional storage media, including, but not limited to, a floppy disk, a compact disk, a magnetic tape, a read only memory, or an optical storage media. Storage media 135 could also be a random access memory, or other type of electronic storage, located on a remote storage system and coupled to the memories of processor 105, processor 115 and workstation 130.

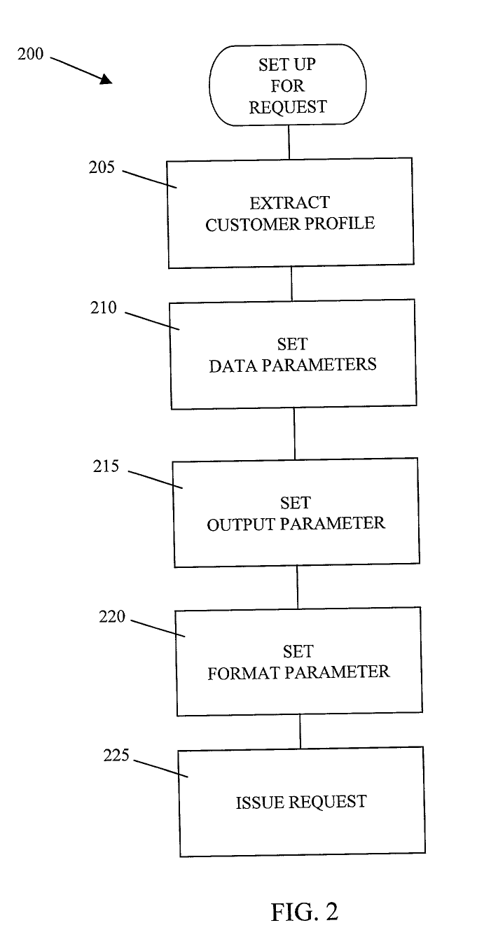

FIG. 2 is a flowchart of a method 200 for setting up a request for a risk analysis, using API call 120 in accordance with the present invention. Method 200 is executed on the client side of system 100 by either processor 105 or workstation 130 under the control of either interface module 110 or 110A, respectively. For convenience, method 200 is described herein from the perspective of processor 105 and interface module 110. Method 200 commences with step 205.

In step 205, a user portfolio is selected to be analyzed. This selection may occur, for example, as a result of a financial service customer's wish to generate a risk measurement of his or her portfolio. The customer expresses this wish by sending a request for the measurement from workstation 130 to processor 105. Thereafter, processor 105 extracts the customer's portfolio parameters from a portfolio database (not shown), which is a part of, or which is coupled to, processor 105. Method 200 then progresses to step 210.

In a preferred embodiment of the invention, the financial service entity has used the functions available via the API to create a service that is accessible to a customer. This service may be in the form of a series of HTML web pages that allow a customer to choose from a number of available features. Therefore, in a preferred embodiment, a customer can choose a feature via a web page delivered by processor 105 to analyze the aggregate risk of a selected portfolio. This choice, made by the customer, i.e., the end user, dictates which API calls processor 105 will make and which parameters it will use.

In step 210, processor 105 sets data parameters, e.g., position details (symbol, quantity, etc.), of the portfolio contents for API call 112. That is the position details are input as data parameters into interface module 110. After step 210, method 200 optionally progresses to step 215, or otherwise progresses to step 220.

Step 215 is an optional step in which processor 105 can set an output parameter to specify a type of calculation to be performed, and a type of result to be returned, by analytical engine 125. Analytical engine 125 returns different results for different values of the output parameter. Table 1 shows several exemplary uses of the output parameter and their corresponding results.

TABLE 1

| OUTPUT | |
|---|---|
| PARAMETER | RESULT |
| 1 | An aggregate risk measurement for a group of financial |
| | instruments. |
| 2 | A comma delimited series containing individual position risk |
| | measurements for each position within a group of financial instruments. |
| 3 | a histogram displaying a comparative graphical display of each |
| | instrument risk measurement. |

After step 215, method 200 progresses to step 220.

In step 220, processor 105 sets a format parameter to define a format in which data is presented from processor 115 to processor 105. Exemplary formats include (1) simple text, (2) a complex data structure such as an array, a table, or an object-oriented programming (OOP) object, and (3) an image such as a picture, a chart, or a graph. Method 200 progresses from step 220 to step 225.

In step 225, processor 105 transmits API call 112 to processor 115. In terms of software operation, interface module 110 sends API call 112 to API 120. API call 112 is also referred to herein as a request.

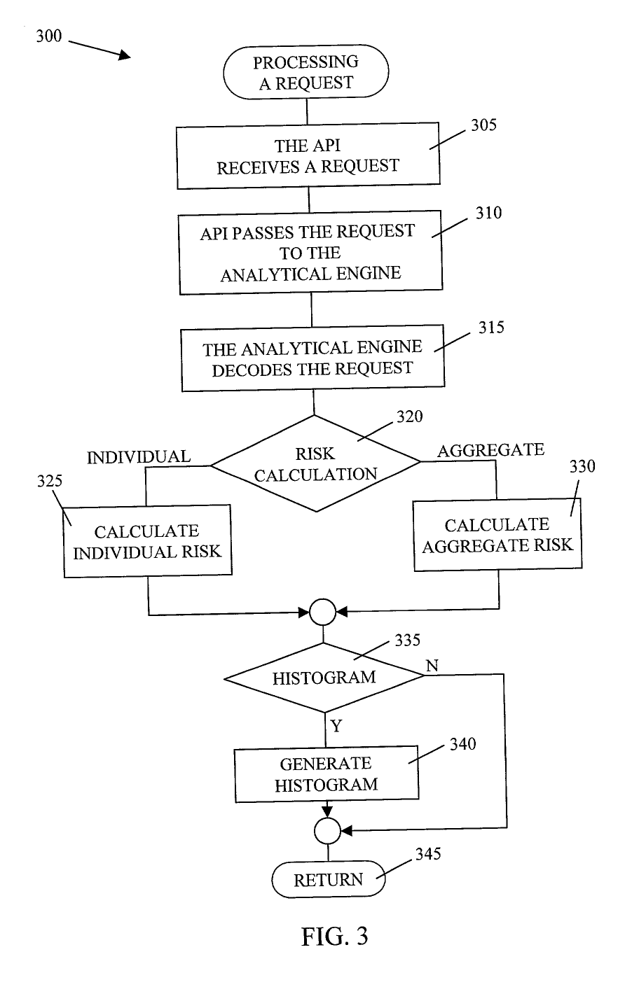

FIG. 3 is a flowchart of a method 300 for processing a request for a risk analysis via API 120 in accordance with the present invention. Method 300 is executed on the server side of system 100 by processor 115 under the control of API 120 and analytical engine 125. Method 300 commences with step 305.

In step 305, processor 310 receives API call 112. More specifically, in terms of software operation, API 120 receives API call 112. As mentioned earlier, API call 112 can be issued by either of processor 105 or workstation 130. After step 305, method 300 progresses to step 310.

In step 310, API 120 passes the request to analytical engine 125. By passing a request, API 120 examines the data delivered to it by API call 112 and extracts portfolio composition data and well as interprets API parameters in order to initiate a specific calculation by analytical engine 125. A given API call 112 may contain data structures that include symbol and quantity information for a given portfolio. Also, this API call 112 may contain parameters that specify exactly which feature of analytical engine 125 should be executed on the given portfolio. It is the job of the API 120 to decipher this information and articulate it to analytical engine 125 based on these parameters. After step 310, method 300 progresses to step 315.

In step 315, analytical engine 125 decodes the request. A request may contain parameters that instruct analytical engine 125 to measure the risk of a portfolio. Therefore analytical engine 125 must read the parameters passed to it to determine what type of risk calculation is desired, and what data will be required to perform this calculation. It extracts parameters (see steps 210, 215 and 220), and based on the parameters, determines which risk analysis function to execute. Several such functions were described earlier, e.g., (1) Financial Instrument Risk Calculation, (2) Financial Instrument Historical Risk Calculation, etc. Analytical engine 125 contains a set of existing capabilities. Based on parameters delivered to it by API 120, it determines which capability to execute. After step 315, method 300 progresses to step 320.

In step 320, analytical engine 125 determines whether the request is for an individual risk calculation or an aggregate risk calculation. Analytical engine 125 makes this determination based on a parameter, i.e. the ‘output’ parameter, which is passed via API call 112 to API 120. The ‘output’ parameter can take on several predetermined values that represent different types of calculations. If the request is for an individual risk calculation, then method 300 progresses to step 325. If the request is for an aggregate risk calculation, then method 300 progresses to step 330.

In step 325, analytical engine 125 calculates individual risk. Analytical engine 125 generates a VaR result for each position in the given portfolio. After step 325, method 300 progresses to step 335.

In step 330, analytical engine 1225 calculates aggregate risk. Analytical engine 125 performs a portfolio wide analysis that results in the overall VaR of the whole given portfolio. After step 325, method 300 progresses to step 335.

In step 335, analytical engine 125 determines, based on the output parameter specified in step 220, whether to generate a histogram. If a histogram is to be generated, then method 300 progresses to step 340. If a histogram is not to be generated, then method 300 progresses to step 345.

In step 340, analytical engine 125 generates a histogram for comparing each instrument risk measurement. Using associated server-side graphics functions, the analytical engine creates a histogram illustrating different VaR values of each position in a given portfolio. After step 340, method 300 progresses to step 345.

In step 345, processor 115 returns API result 114 to the client side device, e.g., processor 105 or workstation 130, that sent API call 112. More specifically, analytical engine 125 passes a result of the risk analysis to API 120, which in turn, dispatches API result 114 to the client side of system 100. When analytical engine 125 completes a desired calculation, the result is returned to data structures residing in API 120. These data structures are then packaged in a specific format that API 120 uses to transmit them over the Internet or a network back to workstation 130 or processor 105.

The following represents an example of API call 112 made using a web programming language requesting the aggregate risk of a group of financial instruments. One example of such a programming language is Cold Fusion, which is available from Macromedia Inc. The portfolio contains three stocks, IBM, LEH and MRL. The quantities of each respectively are 100 shares, 101 shares and 102 shares:

<cfhttp url=“api_PortfolioRisk_URL” method=“post”>

<cfhttpparam type=“FORMFIELD” name=“output” value=“1”>

<cfhttpparam type=“FORMFIELD” name=“period” value=d”>

<cfhttpparam type=“FORMFIELD” name=“number” value=“3”>

<cfhttpparam type=“FORMFIELD” name=“ticker” value=“IBM,LEH,MRL”>

<cfhttpparam type=“FORMFIELD” name=“quantity” value=“100,101,102”>

</cfhttp>

<cfset result=CFHTTP.FileContent)>

The following represents an example of a API method which is accessed via an API call 112. This example uses pseudo code, a lexical description of the executable software.

1. Network connection is opened by client with API 120.

2. API 120 spawns (creates) a new thread or process to handle the network connection.

3. Client transmits the binary information containing the contents of API call 112.

4. API call 112 is received and is stored in memory data structures.

5. API 120 parses the data structures and extracts portfolio information, including ticker symbols and associated quantities for each portfolio position.

6. API 120 parses the data structures and extracts command parameters that indicate a type of risk analysis function to execute.

7. API 120 packages portfolio information into data structures in order to provide analytical engine 125 with necessary input.

8. API 120 initiates analytical engine 125 calculation.

9. API 120 stores analytical engine 125 results in data structures.

10. API 120 converts analytical engine 124 result data structures to a format that can be transmitted over a network connection.

11. API 120 uses the open network connection from (1) to transmit results to client.

12. API 120 closes the network connection.

Risk Calculation:

The following is an example of a parametric VaR calculation, which is one technique of calculating the risk of a plurality of financial instruments. The risk calculation consists of three parts: Returns calculation, Returns Volatility Calculation, and Dollar Risk Calculation.

Returns Calculation

Given a time series of historical price data for a specific financial instrument (or a plurality of financial instruments) in a financial portfolio, a time series consisting of the returns is generated. The returns of the data series is defined as a series whose points are the value of the difference between each successive historical data point in the input data series.

For a given data series, X, the resulting return series, R is calculated by:

Ri=Xi−X(i1),

where i goes from 2 to Length of X. Thus, the resulting time series, R is 1 point shorter than X.

For example,

X={1,2,3,5,8}

R={1,1,2,3}

The periodicity of the calculation is defined by the periodicity of the inputted price series, X. If the period of X is daily, the resulting returns array, R, will have a daily periodicity as well. Conversely, if the period of X is monthly, then the periodicity of R will also be monthly.

Returns Volatility Calculation

For a given a time series of returns data, R, a volatility measurement is calculated. The volatility is calculated by taking the standard deviation of the returns time series.

$$\sqrt{\frac{n \sum {R}_{i}^{2} - {( \sum {R}_{i} )}^{2}}{n ( n - 1 )}}$$

where i goes from 1 to n and n=Length of R. Thus, the result is a volatility calculation for the return series R.

The range of the variable, i, is dependent upon the historical range of the calculation. Limiting i to the last n points in the series, controls the historical sample set of the calculation. For example, a 30 day volatility calculation measurement would involve i ranging from (Length of R)−30 to Length of R. Thus, the sample set for the calculation would therefore be the last 30 days of the series and would yield a 30 day volatility measurement.

Dollar Risk Calculation

Now that a volatility figure has been calculated for a given returns time series, R, one can arrive at a dollar risk figure:

Dollar Risk=Volatility*Scaling Factor,

where the Scaling Factor, S, =A fractional area under a statistical distribution curve. Dollar risk is also known as value at risk (VAR).

In a specific embodiment of the invention, the sampled statistical distribution curve can be a Normal distribution curve.

A Normal distribution is a continuous, bell-shaped, and symmetric distribution. It can be fully described by two parameters, mean and standard deviation. The Normal distribution is symmetric about its mean and can take on values from negative infinity to positive infinity. Using a Normal distribution to scale the volatility measurement assumes that the returns of the given financial instrument (or plurality of instruments) are normally distributed. Using a Normal distribution curve also assumes that the returns of the instrument (or plurality of instruments) are dependent upon applicable risk factors, such as, the price of a stock, or an exchange rate.

There are other distributions that can be used in order to generate scaling factors. These are appropriate under different assumptions of returns dependencies. Returns that are non-linear, or that depend upon non-linear risk factors cannot be modeled accurately using a normal distribution curve. For example, a portfolio consisting of options and mortgage backed securities that depend upon convexity and gamma risk, cannot be accurately modeled using a Normal distribution curve.

A Normal distribution is fully described with just two parameters: its mean μ, and standard deviation, σ. These provide all the information needed to determine any statistical measure of VAR related to the portfolio's profit/loss distribution. For example, if the VAR is defined as the maximum loss that can occur within a 95% confidence interval, the measure of VAR will be:

1.65σ−μ

where 1.65σ maps to 95% of the area under the Normal distribution curve.

And, where μ is the average one-period risk-free return plus a spread for any systematic risk the portfolio may be taking. In practice, where VAR is computed over short horizons, μ is small. Typically, it is set equal to zero. The VAR estimate then simplifies to:

1.65σ

Therefore, the VAR is then the standard deviation of the plurality of instruments multiplied by a scaling factor, in this case, 1.65 standard deviations.

Any suitable technique can be used for the calculation of VaR. For example, the general approaches to VaR computation currently fall into three main categories: parametric, historical simulation, and Monte Carlo.

Parametric VaR, as described above, is most closely tied to modem portfolio theory, as the VaR is expressed as a multiple of a standard deviation of a portfolio's return.

Historical simulation expresses a distribution of portfolio returns as a bar chart or histogram of hypothetical returns. Each hypothetical return is calculated based on actual historical market activity. The VaR then is read from this bar chart or histogram.

Monte Carlo also expresses returns as a histogram of hypothetical returns. In this case the hypothetical returns are obtained by choosing at random from a given distribution of market activity estimated with historical data.

The benefits of the present invention include its ability to service a calculation request from any networked electronic environment. Many existing financial services are composed of dynamically generated hypertext markup language (HTML) (web) user interfaces. The processes generating these user interfaces are constructed using several different scripting programming languages. Some commonly employed languages are, for example, Microsoft Active Server Pages (ASP), Java Server Pages (JSP), Allaire Cold Fusion, and Open Source Perl. In addition, some user interfaces are created using raw, natively compiled languages such as C++, or C. Each of the above mentioned dynamic HTML environments allow a financial service to store an electronic record of a user's investment portfolio and provide that user with a set of related functions. In a preferred embodiment of the system, API 120 is accessed universally through the network layer of each scripting or native language. The final calculation request, i.e., API call 112, may occur as a structured HTTP (hyper text transfer protocol) data transmission.

It should be understood that various alternatives and modifications of the present invention could be devised by those skilled in the art. The present invention is intended to embrace all such alternatives, modifications and variances that fall within the scope of the appended claims.

What is claimed is:

1. A computer system comprising a module for controlling a processor to:
receive a request via a network for a risk analysis of an investment;
pass said request to a risk analysis engine;
receive a result of said risk analysis from said risk analysis engine; and
send said result to a client device via said network.

2. A computer system comprising a module for controlling a processor to:
receive a request via a network for a risk analysis of an investment;
pass said request to a risk analysis engine;
receive a result of said risk analysis from said risk analysis engine; and
send said result to a client device via said network,
wherein said module is embodied in an application program interface (API).

3. The computer system of claim 2, wherein said request is embodied in an API call.

4. The computer system of claim 2, wherein said request includes data describing said investment.

5. The computer system of claim 2,
wherein said risk analysis engine includes a plurality of risk analysis functions, and
wherein said request includes data that selects a member of said plurality of risk analysis functions.

6. A computer system comprising:
a processor;
a risk analysis engine for controlling said processor to perform a risk analysis of an investment; and
an application program interface (API) for controlling said processor to:
(a) receive an API call via a network, wherein said API call includes a request for said risk analysis;
(b) pass said request to said risk analysis engine;
(c) receive a result of said risk analysis from said risk analysis engine; and
(d) send said result to a client device via said network,
wherein said request includes data describing said investment,
wherein said risk analysis engine includes a plurality of risk analysis functions, and
wherein said request includes data that selects a member of said plurality of risk analysis functions.

7. A storage media containing instructions for controlling a processor, said storage media comprising instructions for controlling said processor to:
receive a request for a risk analysis of an investment;
pass said request to a risk analysis engine;
receive a result of said risk analysis from said risk analysis engine; and
send said result to a client device via said network.

8. A storage media containing instructions for controlling a processor, said storage media comprising instructions for controlling said processor to:
receive a request for a risk analysis of an investment;
pass said request to a risk analysis engine;
receive a result of said risk analysis from said risk analysis engine; and
send said result to a client device via said network,
wherein said instructions are embodied in an application program interface (API).

9. The storage media of claim 8, wherein said request is embodied in an API call.

10. The storage media of claim 7, wherein said request includes data describing said investment.

11. The storage media of claim 7,
wherein said risk analysis engine includes a plurality of risk analysis functions, and
wherein said request includes data that selects a member of said plurality of risk analysis functions.

12. An application program interface (API) for controlling a processor to:
receive a an API call via a network, wherein said API call includes a request for a risk analysis of an investment;
pass said request to a risk analysis engine;
receive a result of said risk analysis from said risk analysis engine; and
send said result to a client device via said network,
wherein said request includes data describing said investment,
wherein said risk analysis engine includes a plurality of risk analysis functions, and
wherein said request includes data that selects a member of said plurality of risk analysis functions.
